(19) United States
(12) Patent Application Publication
(10) Pub. No.: US 2014/0120859 A1
(43) Pub. Date: May 1, 2014

(54) Elevated Priority Call Reliability In Multiple SIM User Equipment

(71) Applicant: BROADCOM CORPORATION, Irvine, CA (US)

(72) Inventors: Ozgur Ekici, Escondido, CA (US); Ahmet Ferhat Yildirim, San Diego, CA (US)

(73) Assignee: Broadcom Corporation, Irvine, CA (US)

(21) Appl. No.: 13/660,048

(22) Filed: Oct. 25, 2012

(51) Int. Cl. H04W 72/10; H04W 4/22

(52) U.S. Cl. 455/404.1; 455/450

(57) ABSTRACT

User equipment that includes multiple Subscriber Identity Modules (SIMs) may determine a selected SIM network connection to perform an elevated priority call request. The user equipment may obtain a first network characteristic for a first SIM network connection and a second network characteristic for a second SIM network connection. The user equipment may analyze the first and second network characteristics to determine a selected network connection, which the user equipment may use to perform an elevated priority outgoing call, e.g., an emergency call. The user equipment may obtain the network characteristics, analyze the obtained network characteristics, or determined the selected network connection either before or after recognizing the elevated priority call request for an outgoing call.

### 1. TECHNICAL FIELD

This disclosure relates communication devices with multiple Subscriber Identity Modules (SIMs). This disclosure also relates to elevated priority call reliability in communication devices with multiple SIMs.

### 2. BACKGROUND

Rapid advances in electronics and communication technologies, driven by immense customer demand, have resulted in the widespread adoption of mobile communication devices. The extent of the proliferation of such devices is readily apparent in view of some estimates that put the number of wireless subscriber connections in use around the world at nearly 80% of the world's population. Furthermore, other estimates indicate that (as just three examples) the United States, Italy, and the UK have more mobile phones in use in each country than there are people living in those countries.

Relatively recently, cellular phone manufactures have introduced phone designs that include multiple SIM cards. Each SIM card facilitates a separate connection to the same network or different networks. As a result, the SIMs provide the owner of the phone with, for example, two different phone numbers handled by the same phone hardware. Accordingly, the multiple SIM approach alleviates to some degree the need to carry different physical phones, and improvements in multiple SIM communication devices will continue to make such devices attractive options for the consumer.

### BRIEF DESCRIPTION OF THE DRAWINGS

The innovation may be better understood with reference to the following drawings and description. In the figures, like reference numerals designate corresponding parts throughout the different views.

FIG. 1 shows an example of user equipment with multiple Subscriber Identity Modules (SIMs).

FIG. 2 shows an example of a system for enhanced handling of elevated priority call requests in the user equipment with multiple SIMs.

FIG. 3 shows an example of logic that user equipment may implement as software, hardware, or both.

FIG. 4 shows an example of logic that user equipment may implement as software, hardware, or both.

FIG. 5 shows an example of logic that user equipment may implement as software, hardware, or both.

### DETAILED DESCRIPTION

The discussion below makes reference to user equipment. User equipment may take many different forms and have many different functions. As one example, user equipment may be a cellular phone capable of making and receiving wireless phone calls. The user equipment may also be a smartphone that, in addition to making and receiving phone calls, runs general purpose applications. User equipment may be virtually any device that wirelessly connects to a network, including as additional examples a driver assistance module in a vehicle, an emergency transponder, a pager, a satellite television receiver, a networked stereo receiver, a computer system, music player, or virtually any other device. The discussion below addresses how user equipment that includes multiple (e.g., two) SIMs selects a network connection to perform an elevated priority outgoing call request.

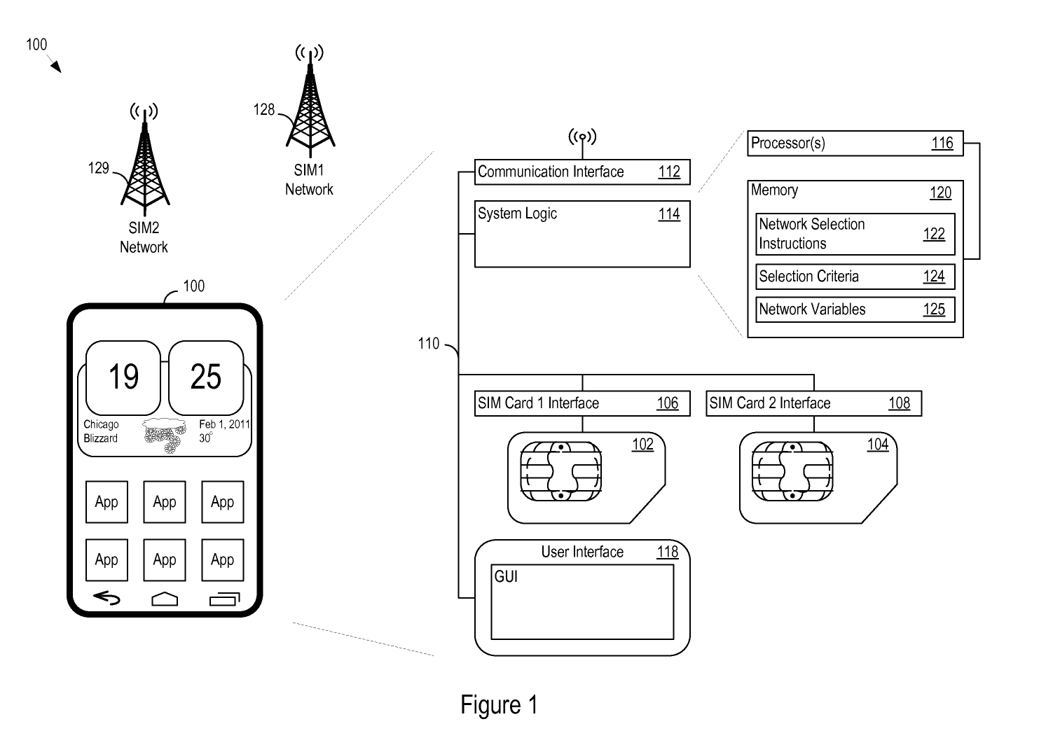

FIG. 1 shows an example of user equipment 100 with multiple SIMs, in this example the SIM1 102 and the SIM2 104. An electrical and physical interface 106 connects SIM1 102 to the rest of the user equipment hardware, for example, to the system bus 110. Similarly, the electrical and physical interface 108 connects the SIM2 to the system bus 110.

The user equipment 100 includes a communication interface 112, system logic 114, and a user interface 118. The system logic 114 may include any combination of hardware, software, firmware, or other logic. The system logic 114 may be implemented, for example, in a system on a chip (SoC), application specific integrated circuit (ASIC), or other circuitry. The system logic 114 is part of the implementation of any desired functionality in the user equipment. In that regard, the system logic 114 may include logic that facilitates, as examples, running applications, accepting user inputs, saving and retrieving application data, establishing, maintaining, and terminating cellular phone calls, wireless network connections, Bluetooth connections, or other connections, and displaying relevant information on the user interface 118. The user interface 118 may include a graphical user interface, touch sensitive display, voice or facial recognition inputs, buttons, switches, and other user interface elements.

The communication interface 112 may include one or more transceivers. The transceivers may be wireless transceivers that include modulation/demodulation circuitry, amplifiers, analog to digital and digital to analog converters and/or other logic for transmitting and receiving through one or more antennas, or through a physical (e.g., wireline) medium. As one implementation example, the communication interface 112 and system logic 114 may include a BCM2091 EDGE/HSPA Multi-Mode, Multi-Band Cellular Transceiver and a BCM59056 advanced power management unit (PMU), controlled by a BCM28150 HSPA+ system-on-a-chip (SoC) baseband smartphone processer. These integrated circuits, as well as other hardware and software implementation options for the user equipment 100, are available from Broadcom Corporation of Irvine Calif. The transmitted and received signals may adhere to any of a diverse array of formats, protocols, modulations, frequency channels, bit rates, and encodings that presently or in the future support communications associated with SIMs. As one specific example, the communication interface 112 may support transmission and reception under the Universal Mobile Telecommunications System (UMTS), 3rd Generation Partnership Project (3GPP), GSM (R) Association, Long Term Evolution (LTE)™ efforts, or other communication technologies, partnerships or standards bodies.

SIM1 102 and SIM2 104 may be on the same or different communication networks, and may be served by the same or different cells. For example, the network controller A 128 may manage a particular cell to which SIM1 102 can connect, while the network controller B 129 may manage a different cell to which SIM2 104 can connect. Accordingly, SIM1 102 may communicate through a first network connection that includes the network controller A 128, while SIM2 104 may communicate through a second network connection that includes the network controller B 129.

Both SIM1 102 and SIM2 104 may share access to the communication interface 112. For example, there may be one set of transceiver circuitry that both SIM1 102 and SIM2 104 share in time division manner. As a result, the system logic 114 may decide which SIM is given use of the communication interface 112, as SIM1 102 and SIM2 104 cannot both be active on the communication interface 112 at the same time.

In one implementation, the system logic 114 includes one or more processors 116 and a memory 120. The memory 120 stores, for example, network selection instructions 122 that the processor 116 executes, network selection criteria 124, and one or more network variables 125. As will be described in more detail below, the system logic 114 may recognize an elevated priority call request for an outgoing call, determine a selected network connection, and perform the outgoing call using the selected network connection.

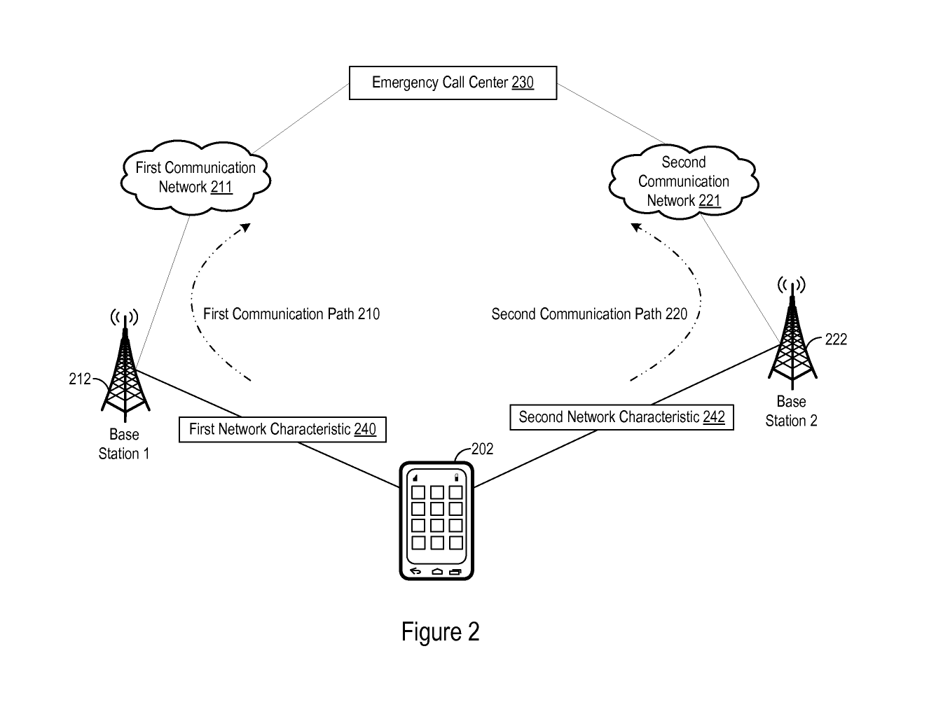

FIG. 2 shows an example of a system 200 for enhanced handling (e.g., through increased reliability) of elevated priority call requests in the user equipment 202 with multiple SIMs. Each SIM in the user equipment 202 may use a corresponding network connection to communicate across. In this example, the user equipment 202 includes two SIMs—SIM1 102 and SIM2 104. The user equipment 202 may communicate with a destination via various communication paths. As seen in FIG. 2, the user equipment 202 may establish a connection with the emergency call center 230 through a first communication path 210 or a second communication path 220. SIM1 102 may establish a first network connection to communicate across the first communication path 210. The first communication path 210 may travel across any network nodes, links, or hops in the first communication network 211. The user equipment 202 may access the first communication path 210 or a particular communication network through a base station or other network controller, such as the base station 212. In a similar way, SIM2 104 may establish a second network connection to communicate across the second communication path 220, e.g., through the second communication network 221 and the second base station 222.

The first and second communication networks may differ in any number of ways, including communication characteristics such as network topology, speed, reliability, bit error rate, coding, congestion, latency, load, or other characteristics. Any number of communication characteristics of the first and second network connections may also vary over time. The communication characteristics of the first and/or second network connections may vary depending on any number of factors, including as examples, the time of day, load on the network, resource availability, hardware failures, environmental effects, the user equipment's proximity to a base station, or other factors.

In operation, the system logic 114 of the user equipment 202 may recognize an elevated priority call request for an outgoing call. The system logic 114 may designate any number of outgoing calls as an elevated priority call request, including, as examples, outgoing calls corresponding to a selected phone number, location, person, place, area code, contact, contact grouping, or others. In one implementation, the system logic 114 may maintain an elevated priority call listing identifying outgoing calls categorized as elevated priority. A memory in the user equipment 202 may identify selected outgoing calls, e.g., phone numbers, categorized as elevated priority call requests. Categorization of elevated priority calls may also be configurable, by the system logic 114, by user request, or in other ways. For instance, the system logic 114 may receive priority configuration requests through a user interface of the user equipment 202. Configuration requests may add or remove one or more phone numbers as elevated priority outgoing calls. The system logic 114 may update an elevated priority call listing in response to receiving a priority configuration request.

As one particular example, the system logic 114 may recognize outgoing emergency calls as an elevated priority call request. An emergency call may refer to a call directed to any recognized emergency number, emergency agency, authority, or service, e.g., police, medical, fire, or other emergency services. Emergency numbers may include “911” in the United States, “112” in Europe, and other emergency numbers as specified by a particular nation or group of nations. The system logic 114 may be pre-programmed to automatically recognize an emergency call as an elevated priority call request, e.g., without any user configuration. Also, the system logic 114 may deny a configuration request to cease identifying an emergency call as an elevated priority call or remove an emergency call number from an elevated priority call listing.

In the example shown in FIG. 2, the system logic 114 of the user equipment 202 recognizes an outgoing emergency call (e.g., a 911 call) as an elevated priority call request. In FIG. 2, the emergency call is routed to an emergency operator or dispatcher located at an emergency call center 230. The likelihood that the user equipment 202 successfully initiates and/or maintains a call connection with the emergency call center 230 may vary depending on which network connection the user equipment performs the emergency call with. In that regard, system logic 114 in the user equipment 202 may select between any number of SIM network connections for handling the elevated priority call request. In FIG. 2, the system logic 114 selects between the first SIM network connection corresponding to SIM1 102 and the second SIM network connection corresponding to SIM2 104 for performing the outgoing emergency call.

The system logic 114 may determine a selected network connection for performing an elevated priority outgoing call according to any selection criteria 124. For instance, the system logic 114 may obtain a first network characteristic 240 of the first SIM network connection, a second network characteristic 242 of the second SIM network connection, or both. The first and second network characteristics may indicate a characteristic of a particular network node, communication path, or communication network through which the user equipment 202 may communicate. The obtained network characteristic may include a characteristic value, e.g., a numerical value, level, or rating, which may measure a particular characteristic of the network connection. In one example, the first and second network characteristics 240 and 242 may be the respective signal strength, congestion, or radio coverage of the first and second network connections. The user equipment 202 may measure such characteristics, or it may receive network management messages that include such information. The first and second network characteristics 240 and 242 may also include characteristics that indicate, as examples, quality of service, security, connection availability reliability, congestion level, resource availability, or other traits with respect to the first or second network connection.

The system logic 114 may obtain the first network characteristic 240, the second network characteristic 242, or both, prior to receiving an elevated priority call request. In this case, the system logic 114 may access previously obtained network characteristics or characteristic values, which the system logic 114 may store as one or more network variables 125 in a memory 120 of the user equipment 202. Then, upon identifying an elevated priority call request, the system logic 114 may determine a selected network connection without the additional step of acquiring network characteristics from associated SIM network connections, thus decreasing the latency, e.g., time, to perform the outgoing call.

In one implementation, the system logic 114 may periodically obtain one or more SIM network characteristics. For example, the system logic may obtain a network characteristic at a periodic rate specified by a configurable period parameter. The system logic 114 may maintain multiple period parameters, such as a separate period parameter for a particular network characteristic, network connection, or both. Moreover, the periodicity specified by a period parameter may vary between network connections, network characteristics, or both. As an additional or alternative option, the system logic 114 may obtain one or more network characteristics on an aperiodic basis as well, e.g., by user request. The system logic 114 may obtain network characteristics or characteristic values, either periodically or aperiodically, as a background program, task, or thread executing on the user equipment 202.

The system logic 114 may also determine a selected network connection prior to recognizing an elevated priority call request. For example, the system logic 114 may perform a selected network determination upon obtaining an updated network characteristic or characteristic value. The system logic 114 may also maintain a network variable 125 indicating which SIM network connection most recently determined as the selected network connection. In this implementation, upon recognizing an elevated priority outgoing call request, the system logic 114 may access the network variable 125 that indicates the most recently determined (or “current”) selected network connection and perform the outgoing call using the particular SIM network connection specified by the network variable 125. In this way, the latency for performing the elevated priority outgoing call may be further reduced by determining the selected network connection prior to receiving the elevated priority call request.

As an additional or alternative option, the system logic 114 may perform any combination of obtaining the first network characteristic 240, obtaining the second network characteristic 242, and determining the selected network connection after recognizing an elevated priority call request. The system logic 114 may do so in order to obtain updated, e.g., current, network characteristics or characteristic values with respect to the first and second network connections. The system logic 114 may then select one of the SIM network connections based on the current network characteristics obtained after identifying the elevated priority call request.

The system logic 114 may determine a selected network connection according to any number of selection criteria 124. The selection criteria 124 may specify analyzing (e.g., by comparing) any type or amount of data, including current network characteristics, past network characteristics, previously selected network connections, or any other network connection data. As examples, the selection criteria 124 may specify selecting the SIM network connection with the highest signal strength, the lowest congestion level, or any combination thereof. As additional examples, the selection criteria 124 may specify comparing historic network characteristic values, such as signal strength, congestion, call success rate, resource availability, and other characteristics of a first and second SIM network connection over a particular time period. The selection criteria 124 may specify analyzing one or more network characteristics over time periods such as 6, 12, 18, or 24 hours, week, month, year, for a particular time or time span in the day, or at a particular location or geographical region, e.g., zip code, city block, or any other geographical bound.

The selection criteria 124 may assign a weight to any number of network characteristics, thus increasing or decreasing the impact of the particular network characteristic in determining the selected network connection. The selection criteria 124 may also take into account the characteristic value difference for particular network characteristics. For example, the selection criteria 124 may specify selecting a first SIM network connection when the current signal strength of the first SIM network connection exceeds the current signal strength of a second SIM network connection by a predetermined threshold. When a particular characteristic value difference, e.g., difference in respective current signal strength, fails to satisfy the selection criteria 124, the selection criteria 124 may specify analyzing the particular network characteristic differently, e.g., signal strength over the past week, or a different network characteristic, e.g., network congestion level.

After determining a selected network connection, the system logic 114 may perform an outgoing call using the selected network connection, store the determined selected network connection as a network variable 125, or both.

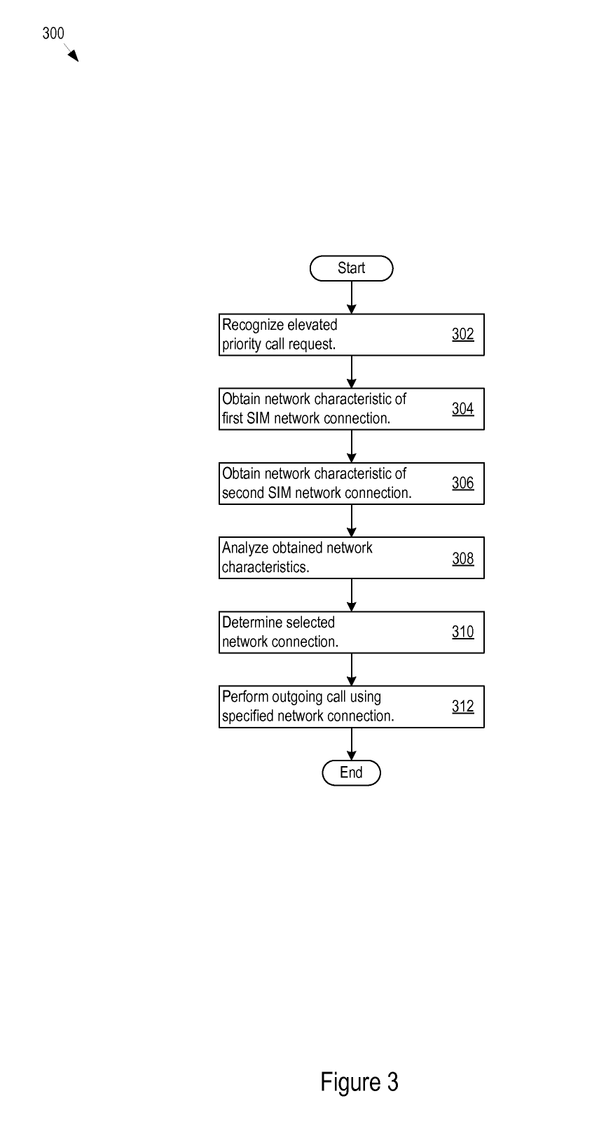

FIG. 3 shows an example of logic 300 that the user equipment 202 may implement as software, hardware, or both. For example, the system logic 114 may implement the logic 300 in software as the network selection instructions 122.

The system logic 114 may recognize an elevated priority request for an outgoing call in the user equipment 202 (302). In response, the system logic 114 may obtain a network characteristic of a first SIM network connection (304), a network characteristic of a second SIM network connection (306), or both. In doing so, the system logic 114 may obtain a network characteristic value with respect to a particular SIM network connection, such as a numerical value or a rating value determined by categorizing obtained network characteristic data into predetermined ratings, e.g., signal strength rating from 1-5 based on obtained network characteristic data. As an example, the system logic 114 may obtain a first signal strength for a first SIM network connection and a second strength for a second SIM network connection.

The system logic 114 may analyze any number of obtained network characteristics (308) to determine a selected network connection (310). As one way of analyzing obtained network characteristics, the system logic 114 may compare obtained network characteristic values, such as signal strength or congestion level. Continuing the example discussed above, the system logic 114 may compare obtained signal strengths and determine the selected network connection as which of the first SIM network connection and second SIM network connection having greater signal strength. As another example, the system logic 114 may compare obtained congestion levels, and determine the selected network connection as which of the first and second SIM network connection that having lesser network congestion, e.g., having available resources. Upon determining the selected network connection, the system logic 114 may perform the elevated priority outgoing call using the selected network connection (312).

In the exemplary logic 300 shown in FIG. 3, the system logic 114 obtains the first network characteristic, obtains the second network characteristic, and determines the selected network connection after recognizing the elevated priority call request. In doing so, the system logic 114 determines a selected network using recently obtained network characteristic values that provide a current indication of the state of the respective SIM network connections. Thus, the system logic 114 may more effectively determine a selected network connection to perform the elevated priority call and increase the likelihood and reliability of initiating and maintaining a call connection to perform the elevated priority outgoing call.

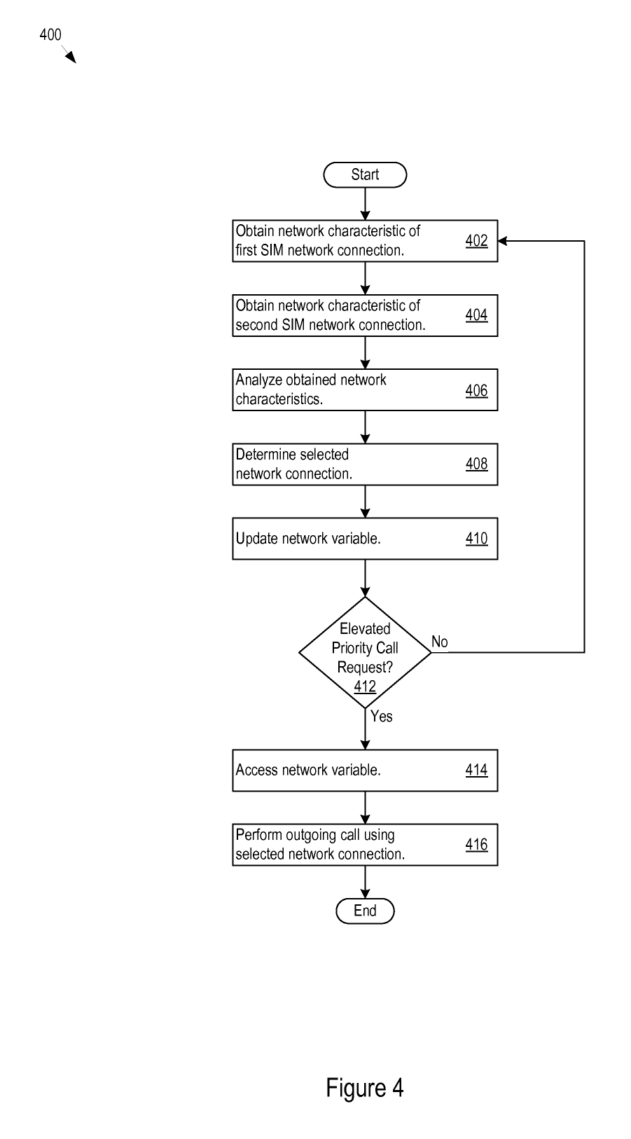

FIG. 4 shows an example of logic 400 that the user equipment 202 may implement as software, hardware, or both. For example, the system logic 114 may implement the logic 400 in software as the network selection instructions 122.

The system logic 114 may obtain a network characteristic of a first SIM network connection (402), a network characteristic of a second SIM network connection (404), or both. As discussed above, the system logic 114 may obtain network characteristics with respect to the first and second SIM network connections periodically, aperiodically, as a background thread, upon user request, or at any other time prior to recognizing an elevated priority call request. The system logic 114 may analyze the obtained network characteristics (406) and determine a selected network connection (408) in any of the ways discussed above. Then, the system logic 114 may update one or more network variables (410) as a result of obtaining the network characteristics or determining the selected network connection.

In one implementation, the system logic 114 may maintain a network variable specifying the most recently determined selected network connection. Thus, upon determining a selected network connection, the system logic 114 may update the network variable to reflect the most recent determination. The system logic 114 may, for example, update the network variable to specify a SIM network connection with the highest signal strength, the lowest network connection level, the greatest radio coverage, or according to any other selection criteria 124 previously discussed above.

Regardless of whether the system logic 114 recognizes an elevated priority call request or not (412), the system logic 114 may consistently, e.g., periodically, obtain network characteristics with respect to the first and second SIM network connections, analyze the obtained network characteristics, determine a selected network connection, and update one or more network variables. In this way, the system logic 114 may ensure consistent updates to the network variable specifying the most recently selected network connection. When the system logic 114 recognizes an elevated priority call request for an outgoing call, the system logic 114 may access the network variable specifying the most recently determined selected network connection (414) and perform the outgoing call using the specified selected network connection (416).

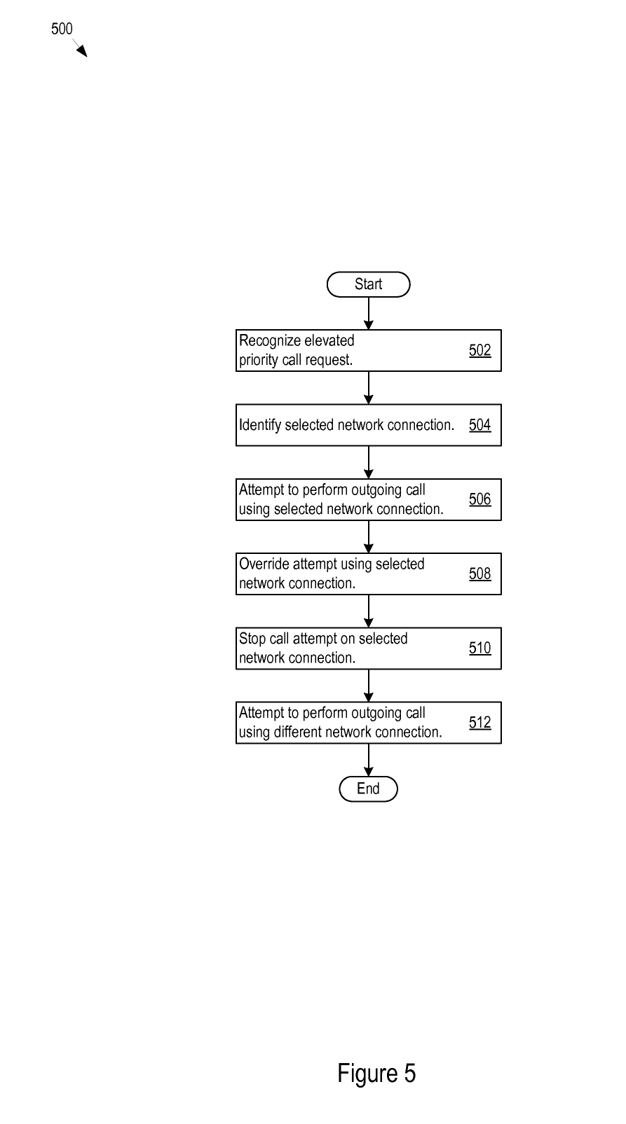

FIG. 5 shows an example of logic 500 that the user equipment 202 may implement as software, hardware, or both. For example, the system logic 114 may implement the logic 500 in software as the network selection instructions 122.

The system logic 114 may recognize an elevated priority call request for an outgoing call (502). The system logic 114 may also identify a selected network connection (504) in any of the ways discussed above, e.g., by obtaining network characteristics and determining a selected network connection or by accessing a network variable specifying a selected network connection. Then, the system logic 114 may attempt to perform the elevated priority outgoing call using the selected network connection (506). As one example, the system logic 114 may communicate with a base station or network controller associated with the selected network connection in order to establish a call connection for performing the outgoing call, e.g., by sending a resource request message to the network controller.

While attempting to perform the elevated priority outgoing call using the selected network connection, the system logic 114 may override the call attempt (508). For example, the system logic 114 may override the outgoing call attempt in response to identifying a congestion indication from the selected network connection. The system logic 114 may identify a congestion indication, for example, upon receiving a resource rejection message sent from a network controller of the selected network connection. As another example, the system logic 114 may identify a congestion indication when the system logic 114 fails to receive a response to a previously sent resource request message before a timing congestion threshold elapses. The system logic 114 may determine that the lack of response from the selected network connection or the network controller indicates unavailability of resources in the selected network connection to perform the elevated priority outgoing call. The system logic 114 may also override the outgoing call attempt on the selected network connection when, as examples, the call attempt fails to establish a connection after a predetermined timing threshold or in response to any other call failure indication.

The system logic 114 may stop the attempt to perform the elevated priority outgoing call using the selected network connection (510), for example by instructing a communication resource in the user equipment 202 to cease communicating across the selected network connection. Then, the system logic 114 may attempt to perform the elevated priority outgoing call on a different, e.g., any non-selected, SIM network connection instead (512). The system logic 114 may do so by reassigning the communication resource to communicate across the different SIM network connection instead.

As described above, the system logic 114 may determine a selected network connection to perform an elevated priority outgoing call request. By analyzing obtained network characteristics, the system logic 114 may select a SIM network connection that increases the likelihood of establishing and maintaining a call connection. In doing so, the system logic 114 may increase the reliability of performing the elevated priority outgoing call. This increased reliability may be critical during emergency situations, when quickly and reliably establishing a call connection can carry significant, e.g. life-changing, consequences. The system logic 114 may also take additional steps to lower the latency for performing the elevated priority outgoing call, such as by obtaining network characteristics and/or determining a selected network connection at particular times prior to receiving an elevated priority call request.

Also, performing an elevated priority call using a selected network connection may provide an increased likelihood that a subsequent or follow-up call may be successfully received by the user equipment 202. For example, the user equipment 202 may perform an emergency call using a selected network connection with, as examples, greater signal strength and/or lesser network congestion than other non-selected SIM network connections. A subsequent or follow-up call from an emergency call dispatch or operator may be directed to the user equipment 202 using the selected network connection, as opposed to a non-selected network connection with lesser signal strength and/or greater network congestion than the selected network connection.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above. While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method comprising:
in a user equipment:
recognizing an elevated priority call request for an outgoing call, and in response:
obtaining a network characteristic of a first subscriber identity module (SIM) network connection, a second SIM network connection, or both;
analyzing the network characteristic to determine, for the outgoing call, a selected network connection from among the first SIM network connection and the second SIM network connection; and
performing the outgoing call using the selected network connection.

2. The method of claim 1, where:
obtaining comprises:
obtaining a first network characteristic value with respect to the first SIM network connection; and
obtaining a second network characteristic value with respect to the second SIM network connection; and
where analyzing comprises:
comparing the first and second network characteristic values.

3. The method of claim 1, where obtaining comprises:
prior to recognizing the elevated priority call request for the outgoing call:
obtaining a first network characteristic value with respect to the first SIM network connection;
obtaining a second network characteristic value with respect to the second SIM network connection; and
where analyzing comprises:
comparing the first and second network characteristic values.

4. The method of claim 3, where obtaining comprises:
obtaining the first network characteristic value periodically, as specified by a first period parameter.

5. The method of claim 4, where obtaining comprises:
obtaining the second network characteristic value periodically, as specified by a second period parameter different from the first period parameter.

6. The method of claim 1, where:
obtaining comprises:
obtaining, as the network characteristic, a first signal strength for the first SIM network connection and a second signal strength for the second SIM network connection; and
where analyzing comprises:
determining which of the first SIM network connection and the second SIM network connection has greater signal strength.

7. The method of claim 1, where:
obtaining comprises:
obtaining, as the network characteristic, a first network congestion for the first SIM network connection and a second network congestion for the second SIM network connection; and
where analyzing comprises:
determining which of the first SIM network connection and the second SIM network connection has less network congestion.

8. A device comprising:
a first subscriber identity module (SIM) corresponding to a first SIM network connection;
a second SIM corresponding to a second SIM network connection different from the first SIM network connection;
a memory storing:
a network variable characterizing the first SIM network connection, the second SIM network connection, or both; and
network selection logic operable to:
update the network variable using a current network characteristic of the first SIM network connection, the second SIM network connection, or both; and
identify an elevated priority call request for an outgoing call; and in response:
perform the outgoing call using a SIM network connection selected according to the network variable.

9. The device of claim 8, where the current network characteristic comprises network signal strength; and
where the network selection logic is operable to the update the network variable to specify a SIM network connection with highest signal strength.

10. The device of claim 8, where the current network characteristic comprises network congestion level; and
where the network selection logic is operable to the update the network variable to specify a SIM network connection with lowest network congestion level.

11. The device of claim 8, where the current network characteristic comprises radio coverage; and
where the network selection logic is operable to the update the network variable to specify a SIM network connection with greatest radio coverage.

12. The device of claim 8, where the network selection logic is operable to update the network variable by:
obtaining a first network characteristic value for the first SIM network connection;
obtaining a second network characteristic value for the second SIM network connection; and
selecting between the first and second network characteristic values to use to update the network variable.

13. The device of claim 8, where the network selection logic is further operable to periodically update the network variable by periodically obtaining current network characteristic values for the first and second SIM network connections.

14. The device of claim 8, where the outgoing call comprises an emergency call.

15. A device comprising:
a first subscriber identity module (SIM) corresponding to a first SIM network connection;
a second SIM operable corresponding to a second SIM network connection different from the first SIM network connection; and
emergency network selection logic operable to:
identify an outgoing emergency call request; and in response:
determine a selected network connection from among the first SIM network connection and the second SIM network connection by analyzing predetermined selection criteria; and
attempt to perform an emergency call using the selected network connection.

16. The device of claim 15, where the predetermined selection criteria comprises:
selecting a SIM network connection with highest signal strength.

17. The device of claim 15, where the predetermined selection criteria comprises:
selecting a SIM network connection with lowest network congestion.

18. The device of claim 15, where the emergency network selection logic is further operable to:
while attempting to perform the emergency call using the selected network connection:
identify a congestion indication from the selected network connection, and in response:
stop the attempt to perform the emergency call using the selected network connection; and
attempt to perform the emergency call using a non-selected network connection instead of the selected network connection.

19. The device of claim 18, where the emergency network selection logic is operable to identify the congestion indication by receiving a resource rejection message sent from a network controller associated with the selected network connection.

20. The device of claim 18, where the emergency network selection logic is operable to attempt to perform the emergency call by:
sending a resource request message to a network controller associated with the selected network connection; and
where the emergency network selection logic is operable to identify the congestion indication when no response is received from the network controller before a congestion timing threshold elapses.
